(19) United States
(12) Patent Application Publication
(10) Pub. No.: US 2011/0217417 A1
(43) Pub. Date: Sep. 8, 2011

(54) PHENOLIC ANTIOXIDANT-SUPPLEMENTED INFUSION BEVERAGE

(76) Inventor: Daniel Perlman, Arlington, MA (US)

(21) Appl. No.: 12/435,394

(22) Filed: May 4, 2009

(51) Int. Cl. A23L 1/30; A23L 1/302; A23F 3/00; A23F 5/00; A23G 1/48; A23L 2/52

(52) U.S. Cl. 426/72; 426/590; 426/598; 426/597; 426/595; 426/593

(57) ABSTRACT

A dry composition that is brewed with potable liquid to produce an infusion beverage and methods of using such compositions are described. The composition includes a first amount of fruit and/or vegetable-derived particulate solids combined with a second pre-measured amount of a particulate bioactive component-containing material, advantageously an antioxidant-rich material. When immersed in the liquid the composition releases the phenolic antioxidants to produce a serving of the beverage. The bioactive component-containing material is advantageously configured and sized to remain substantially uniformly distributed throughout the dry composition.

### RELATED APPLICATIONS

NOT APPLICABLE.

### FIELD OF THE INVENTION

The present invention relates to compositions and methods for supplementing infusion beverage-producing vegetable materials with phenolic antioxidants such as those contained in grape seeds and grape seed extracts.

### BACKGROUND OF THE INVENTION

The following discussion is provided solely to assist the understanding of the reader, and does not constitute an admission that any of the information discussed or references cited constitute prior art to the present invention.

The present invention concerns teas, coffees and other infusion beverages that are freshly prepared with hot water, in which the water dissolves, extracts and/or releases soluble flavors and micronutrients from fruit and vegetable particulate solids (e.g., Camellia and herbal tea materials, ground coffee beans, cocoa and the like). In the present invention, these beverage-producing solids are supplemented to produce novel compositions using phenolic antioxidants from exogenous sources.

Notwithstanding the presence of caffeine, that some people avoid by selecting decaffeinated Camellia sinensis-based teas (abbreviated “Camellia teas” herein), these teas provide substantial health benefits and an advantage over most herbal teas because they contain high levels of bioactive catechin-type antioxidants. These include epicatechin (EC), epicatechin gallate (ECG), epigallocatechin (EGC) and epigallocatechin gallate (EGCG), the latter being the most abundant catechin in tea. During the natural fermentation of teas following harvesting and drying, an increasing proportion of the catechins experience natural oxidation and polymerization to form a variety of theaflavin and theaflavin gallate molecules that are also beneficially bioactive. Of the Camellia teas that include white, green, Oolong and black teas, the white teas experience the least oxidation while black teas experience the most oxidation. Phenolic antioxidants constitute as much as 10% of the dry weight of Camellia tea leaves.

Herbal teas are typically caffeine-free, and a few of them, e.g., peppermint and blackberry/raspberry, contain natural antioxidants. However, when compared with Camellia sinensis-based teas, most herbal teas provide little antioxidant. A partial list of dried vegetable ingredients in herbal teas marketed, for example, by the Hain-Celestial Group, Inc. (Boulder, Colo.) include the following: eleuthero, peppermint, spearmint, ginger, chamomile, lemon grass, licorice, catnip, tilia flowers, hibiscus, rosehips, chicory, chicory root, blackberry leaves, hawthorn berries, orange peel, lemon peel, cardamom, nutmeg, lemon myrtle, and wild cherry bark. With the exception of mint and blackberry leaf teas, most commercial herbal teas brewed from such ingredients contain very limited amounts of phenolic antioxidants. The more antioxidant-rich herbs can be used in only small quantities in brewed teas because of their strong flavors, and are better suited for cooked and baked foods. The latter herbs include cloves, allspice, cinnamon, rosemary, thyme, marjoram, oregano and sage.

While water-soluble Camellia leaf extracts that contain high levels of EGCG antioxidant are commercially available and might be considered useful for supplementing herbal teas, these extract products can be costly and may contain up to 10% by weight of undesirable caffeine. If such extracts are decaffeinated, often up to 1% by weight caffeine remains in the product. Furthermore, volatile synthetic solvents are often used to extract the caffeine, while desirable flavors are lost. Use of these synthetic solvents prevents a food or beverage fortified with the extract from being certified and labeled as “organic” under current USDA National Organic Program rules.

A review of the U.S. Patent Office data-base from 1976 to the present, and using the search terms “herbal tea” and “antioxidant” or “polyphenols” reveals little prior art of relevance pertaining to antioxidant-fortified herbal teas. Ashikawa in U.S. Pat. No. 6,180,160 describes an herbal tea prepared from banana flowers, and believed to contain endogenous antioxidants.

There are many fruit-derived materials that can provide high levels of antioxidant compounds that are beneficial to ones health, e.g., the skin and seed extracts from grapes, as well as many other fruit and vegetable materials such as acai berries, pomegranates, and the like. These phenolic compounds include, but are not limited to, the monomeric single ring phenolic compounds, e.g., benzoic and cinnamic acid derivatives such as gallic and coumaric acids, and the polyphenolic compounds such as the two ring stilbene derivatives, e.g., resveratrol, the three ring compounds including the flavonoid derivatives such as the flavanols, flavonols, and anthocyanidins. As indicated above, the catechins are well known flavonoids (flavan-3-ols), and make up as much as 10% of the dry weight of fresh Camellia tea leaves but are generally accompanied by undesirable caffeine upon extraction from the leaves.

Many health benefits have been attributed to the dietary consumption of one group of natural polyphenolic antioxidants known as the proanthocyanidins (herein abbreviated PAs or PA antioxidants) owing to the influence of these antioxidants on cellular physiological processes. A partial list of health conditions that have been reported to benefit from regular ingestion of PAs are as follows: heart disease and atherosclerosis, pancreatic inflammation, cancer cell proliferation, kidney, lung and heart cell damage (e.g., damage caused by chemotherapeutic drug treatments). Related polyphenolic antioxidants have been shown to beneficially modulate or control blood platelet aggregation, LDL oxidation, endothelial dysfunction, rheumatoid arthritis and leukemia cell propagation. A bibliography that encompasses much of the recent research (years 2000-2005) involving polyphenolic antioxidants and their role in controlling disease is provided in the book, Muscadine Medicine by Hartle, Greenspan and Hargrove (2005) ISBN Number 1-4116-4397-6. More specifically, with regard to the health benefits provided by PAs in the diet, several informative review articles are available at, for example, http://www.blackwell-synercgy.com/doi/pdf/10.1111/i.1469-8137.2004.01217.x and at http://repositories.cdlib.org/cgi/viewcontent.cgi?article=1045&context=uclabiolchem/nutritionnoteworthy

The antioxidants present in wines and purple grape juices have received a great deal of attention in recent years. Some examples of research involving grape antioxidants are as follows:

1) O'Byrne et al. Am J Clin Nutr (2002) 76(6):1367-1374 who compare two groups of healthy adults consuming either vitamin E (400 IU RRR-alpha-tocopherol) per day or 10 ml Concord grape juice (CGJ) per kg body weight per day for two weeks. Whereas the serum ORAC value (Oxygen Radical Absorbance Capacity) and the resistance of plasma LDL cholesterol to oxidation were increased to comparable extents by both treatments, CGJ was significantly more effective than vitamin E in protecting plasma proteins against oxidation.

2) Frankel et al. J Agric Food Chem (1998) 46:834-838 and Ghiselli et al. J Agric Food Chem (1998) 46:361-367 have shown that the anthocyanin polyphenolic antioxidants in CGJ and red wine strongly retard LDL lipid peroxidation.

3) Freedman et al. Circulation (2001) 103(23):2792-2798 incubated blood platelets with dilute purple grape juice (PGJ). This led to beneficial inhibition of platelet aggregation, enhanced platelet-derived nitric oxide release and decreased oxidative activity (superoxide production). This was confirmed in vivo with healthy human subjects consuming 7 ml PGJ per kg body weight per day for 2 weeks, as platelet aggregation was inhibited, platelet-derived nitric oxide production nearly doubled, superoxide production decreased by about ⅓, plasma vitamin E levels increased and plasma antioxidant status improved.

4) Osman et al. J Nutr. (1998) 128(12):2307-2312 describes the role of platelet aggregation in contributing to atherosclerosis and acute thrombosis formation. Gastric administration of 5-10 ml PGJ per kg body weight was capable of reducing platelet aggregation in both dogs and monkeys, whereas neither orange juice nor grapefruit juice showed such activity. The authors concluded that grape juice is very effective because it contains high levels of the flavonoids-quercetin, kaempferol and myricetin that are known to be effective inhibitors of platelet aggregation in vitro, whereas the citrus juices contain other flavonoids that are poor inhibitors of platelet aggregation.

5) Ko et al. J Med Food (2005) 8(1):41-46 evaluated the antioxidant status in human plasma for up to 2 hours following consumption of 150 ml of nine different fruit juices by healthy adult males, using the method of measuring dichlorofluorescein fluorescence whose intensity indicates the level of reactive oxygen species in the plasma. Grape juice was the only juice to exert a persistent antioxidant activity that depressed the fluorescent intensity for over two hours following ingestion.

6) Ariga Biofactors (2004) 21(1-4):197-201 describes the PA antioxidants found in grape seed extracts. These compounds were found to be substantially more active than either vitamin C or vitamin E in aqueous systems, and were shown to slow the progression of a number of diseases in animal models. In a separately published USDA database (www.nal.usda.gov/fnic/foodcomp/Data/PA/PA.html), it has been reported that among a large number of juices and beverages tested, Concord purple grape juice contained the highest concentration of the PAs (124 mg per 8 oz serving).

7) Shi et al. J Med Food (2003) 6(4):291-299 describe grape seed waste from production of grape juice in which the seed contains 5-8% polyphenols, mainly flavonoids, including gallic acid, the monomer flavanols catechin, epicatechin, gallocatechin, epigallocatechin, epicatechin 3-O-gallate, and procyanidin dimers, trimers and higher polymers. The antioxidant power of the grape seed polyphenolic PAs is claimed to be 20 times greater than vitamin E and 50 times greater than vitamin C.

Grape seed extracts and other polyphenolic antioxidant-containing extracts have been prepared from fruit and vegetable materials using water, alcohol and acidified alcohol extraction methods, for example. Exemplary patents employing alcohol to extract and purify antioxidants from fruit and vegetable materials include U.S. Pat. Nos. 7,306,815; 7,087,259; 6,960,360; 6,569,446; 6,509,054; 6,238,673; and 5,773,262.

### SUMMARY OF THE INVENTION

Infusion beverages, especially herbal teas, are very popular. However, most such beverages commonly do not provide all of the bioactive food ingredients found in teas prepared from dried Camillia sinensis, and especially do not provide the levels of phenolic antioxidants found in the Camillia sinensis teas. This invention provides a mechanism to effectively supplement herbal teas as well as a variety of other infusion beverages with phenolic antioxidants as well as with other bioactive ingredients utilizing rapid dispersion particulates and/or coatings.

Thus, a first aspect of the invention concerns a dry composition that is brewed with water to produce an infusion beverage. The composition includes fruit-derived and/or vegetable-derived particulate solids that provide flavor in the infusion beverage, and a separate artificially-created bioactive component-containing particulate material, where the bioactive component is released into the infusion beverage and where the particulate bioactive-component-containing material is configured to remain substantially distributed throughout the dry composition.

In certain embodiments, the bioactive component-containing material contains a plurality of bioactive components, e.g., 2, 3, 4, or more, or at least that number of bioactive components; the bioactive component is or includes at least one water-dispersible (e.g., water-soluble) phenolic antioxidant, vitamin, mineral, and/or flavorant; the artificially-created bioactive component-containing particulate material are created by a process involving addition of bioactive material to carrier particles (e.g., soaking and drying), agglomeration of smaller particles of bioactive material and/or smaller particles of bioactive component-containing material (e.g., using pressure with or without heat and with or without one or more binders).

Also in certain embodiments, the particles of the bioactive component-containing particulate material are agglomerate particles, e.g., the agglomerate particles are agglomerates of particles of phenolic antioxidant-containing material, for example, grape seed extract and/or grape seed flour; the phenolic antioxidant-containing material includes grape seed extract or comminuted grape seed particles; the bioactive component-containing particulate material is a plant derived particulate carrier material carrying the bioactive component, e.g., carrying at least 5, 10, 15, 20, 25, 30, 40, 50, 60, 70, 80, 90, 100, 125, 150, 175, or 200 percent by weight of bioactive component or bioactive component-containing material; a plant derived particulate carrier material is or includes corncob particles (e.g., an absorbent corncob carrier material, such as one derived from the woody ring of corncobs), rice hull particles, nut shell particles, or a combination thereof;.

In particular embodiments, the bioactive component-containing particulate material is a particulate material as specified for an embodiment of the following aspect; the bioactive component-containing particulate material is configured such that it is substantially completely retained by a pre-selected filter material; the bioactive component-containing particulate material is contained within and substantially retained by a filter material.

Also in certain embodiments, the dry composition and/or active component-containing particulate material are as described for the following aspect.

A related aspect provides a dry composition that is brewed with hot water to produce an infusion beverage. The infusion beverage contains a first pre-measured amount of fruit-derived or vegetable-derived dry particulate solids or both that provide flavor, combined with a second pre-measured amount of bioactive component-containing material, e.g., phenolic antioxidant-containing material, which is configured to remain distributed throughout and/or around the fruit-derived and/or vegetable-derived dry particulate solids during normal transport.

In certain embodiments, the bioactive component-containing material is or includes antioxidant-containing material, preferably sufficient to release during brewing at least 15, 20, 25, 30, 40, 50, 75, 100, 150, or 200 mg of water-dispersible (e.g., water-soluble) phenolic antioxidants (measured as gallic acid equivalents) per serving of the beverage; the phenolic antioxidants are derived from the seeds of non-fermented grapes; the at least 25 mg (or other amount as specified above) of water-dispersible (e.g., water-soluble) phenolic antioxidants are released during brewing within 5 minutes after adding at least 4 ounces of hot water at a temperature of between 70 and 100° C. (e.g., at about 80° C.).

In advantageous embodiments, the fruit and/or vegetable-derived particulate solids are selected from the group consisting of teas, coffees, and cocoa-containing particulate solids; the beverage is a tea is selected from the group consisting of Camellia-based teas and non-Camellia-containing herbal teas; the fruit or vegetable-derived particulate solids are herbal teas; the beverage is substantially caffeine-free.

For particular embodiments, the water-dispersible (e.g., water-soluble) phenolic antioxidants and/or other bioactive component reside on a porous filter material (e.g., a filter bag containing the composition) that releases the antioxidants and/or other bioactive component during brewing of the infusion beverage.

For some embodiments, the bioactive component-containing material, e.g., antioxidant-containing material, is particulate material; the bioactive component-containing particulate material is confined within a filter material; the bioactive component-containing particulate material is confined within a filter material and is sized to be substantially completely retained by that filter material; the bioactive component-containing particulate material is configured and sized so that at least 80, 85, 90, 95, or 97% by weight of the material is retained by a sieve having 0.13 mm sieve openings; the bioactive component-containing particulate material is configured and sized so that at least 80, 85, 90, 95, or 97% by weight of the material is retained by a sieve having 0.21 mm sieve openings; the bioactive component-containing particulate material is configured and sized so that at least 80, 85, 90, 95, or 97% by weight of the material is retained by a sieve having 0.30 mm sieve openings; the bioactive component-containing particulate material is configured and sized so that at least 80%, 90%, 95%, or essentially 100% by weight of the material passes through a sieve having 2.0 mm sieve openings while at least 95% by weight of the material is retained by a sieve having 0.13 mm sieve openings; the bioactive component-containing particulate material is configured and sized so that at least 80, 85, 90, 95, or 97% by weight of the material passes through a sieve having 1.2 mm sieve openings and is retained by a sieve having 0.21 mm sieve openings; the bioactive component-containing particulate material is configured and sized so that at least 80, 85, 90, 95, or 97% by weight of the material passes through a sieve having 1.0 mm sieve openings and is retained by a sieve having 0.30 mm sieve openings.

For some embodiments, the antioxidant-containing material is or includes comminuted grape seeds or grape seed extract or both; between 0.10 and 4.0 g, 0.20 and 3.5 g, 0.25 g and 3.0 g, 0.4 and 3.0 g, 0.7 and 3.0 g, 1.0 and 3.0 g, 2.0 and 4.0 g, 0.2 and 2.0 g, or 0.2 and 1.0 g of comminuted grape seeds are provided per serving of the beverage; at least 50, 60, 70, 80, or 90% by weight of the water-dispersible (e.g., water-soluble) phenolic antioxidants contained in the comminuted grape seeds is released during brewing within 5 minutes after adding at least 4 ounces of hot water at a temperature of between 80° C.; the comminuted grape seeds are provided in a physical form selected from the group consisting of broken grape seeds, grape seed flour, granulated grape seed flour, agglomerated grape seed flour, and combinations thereof (preferably allowing rapid release of the phenolic antioxidants into the infusion beverage); the comminuted grape seeds are prepared from grape seeds that have been pressed to remove endogenous grape seed oil; the antioxidant-containing material is or includes grape seed extract, where the grape seed extract contains at least 60, 70, 80, 90, or 95% by weight phenolic antioxidants measured as gallic acid equivalents; the antioxidant-containing material is or includes grape seed extract, where the grape seed extract is prepared without the use of any synthetic chemical solvent.

In certain embodiments, the dry composition and/or bioactive component-containing particulate material is as described for the preceding aspect.

Another related aspect concerns a beverage prepared using a composition of one of the above aspects, including all embodiments thereof.

Yet another related aspect concerns a bioactive component-containing particulate material which is or includes particles within a pre-selected size range carrying at least one artificially added bioactive component (e.g., phenolic antioxidants) configured such that the bioactive component is substantially released within 5 minutes in water at 80 degrees C.

In particular embodiments, the bioactive component-containing particulate material is a particulate material as described for a dry composition aspect above.

A related aspect concerns a method for preparing or producing particulate material as described in the preceding aspect. In certain embodiments, the particulate material is prepared by exposing absorbent particulate material (e.g., corn cob particles) to a solution or suspension of the bioactive component and drying absorbed or adsorbed solution or suspension in the particles of the absorbent particulate material. In other embodiments, the particulate material is prepared by forming a sheet of bioactive component-containing material (e.g., antioxidants), and breaking the sheet into particles. Usually the particles from the broken sheets will be screened to provide particles within a desired particle size range.

Still another related aspect provides a method of producing an infusion beverage by combining a quantity of the dry composition of an aspect above with at least 4 fluid ounces of hot water at a temperature of between 70 and 100° C. (e.g., approximately 70, 75, 80, 85, 90, or 95 degrees C.), where the relative quantities of the dry composition and the water are suitable for forming the infusion beverage, and brewing the combination of the dry composition and the water for a time interval sufficient to release substantial amounts of the phenolic antioxidants and/or other bioactive components (e.g., at least 25 mg of the phenolic antioxidants) into the beverage, thereby forming an bioactive component-supplemented (e.g., phenolic antioxidant-supplemented) infusion beverage.

In certain embodiments, the dry composition is packaged in single serving packaging; the quantities of dry composition and water used are selected to provide a single serving of the beverage.

Additional embodiments will be apparent from the Detailed Description and from the claims.

### DETAILED DESCRIPTION OF THE PREFERRED EMBODIMENTS

This invention relates to compositions and methods for introducing pre-measured amounts of beneficial phenolic antioxidants, e.g., grape seed-derived phenolic antioxidants, into the dry particulate vegetable materials that are brewed to produce hot water infusions such as herbal teas, Camellia teas, coffees, and other beverages. While traditional Camellia sinensis-based teas provide substantial amounts of natural catechin-type polyphenolic antioxidants, neither these teas nor herbal teas nor regular coffees provide the benefits of fruit-derived antioxidants.

In the present invention, polyphenolic antioxidants, e.g., contained in grape seed extracts or in comminuted grape seeds, are used to introduce proanthocyanidins (PAs or PA antioxidants) and/or other phenolic antioxidants and/or other bioactive components into such beverages. Applicant has found that the dosing and delivery of an antioxidant extract into an infusion beverage can be facilitated by providing phenolic antioxidant-carrying materials with the dry composition to be used for making infusion beverages. For example, the phenolic antioxidant-carrying materials may be in the form of particles sized to correspond to the primary components for creating the infusion beverage. The particles can be created, for example, as agglomerated smaller particles or as carrier material particles that hold an antioxidant extract (or other preparation of bioactive component(s)) that substantially mix with the dry infusion-producing vegetable materials. Upon immersion in water of appropriate temperature, such particles will rapidly release the phenolic antioxidants (and/or other bioactive components) for inclusion into the infusion during brewing. One advantageous such carrier material, in the form of small absorbent particles, is obtained from the woody portion of the corncob.

In addition, as indicated above, development of the method for adding phenolic antioxidants to infusion beverages further led to the realization that the method can also be used for adding other bioactive components to infusion beverages. Examples include vitamins, minerals, amino acids, and flavorants.

### Carrier Particles

As described herein, an advantageous approach for this invention utilizes carrier material particles which carry and rapidly release antioxidants and/or other bioactive components. A number of different carrier materials and bioactive components can be used; a useful example, including antioxidant extracts, is described below.

An example of a water-soluble antioxidant extract that is a useful source of PA antioxidants is known as ActiVin® (produced by San Joaquin Valley Concentrates, Inc., Fresno, Calif.). It is a concentrated viniferous grape seed extract available as an aqueous solution (e.g., approximately 20-25% by weight antioxidants dissolved in water), or as a spray-dried powder. This powder contains a high level, i.e., at least 90% by weight, of mixed phenolic antioxidants. To deliver these antioxidants into freshly brewed infusion beverages, i.e., tea or coffee, Applicant sought a particulate carrier material for the ActiVin® extract that could be combined with conventional infusion particulates, e.g., tea leaf particles in tea bags or coffee grounds, for brewing in hot water with rapid release of the extract into the water.

A number of properties are considered important if a carrier material for antioxidants and/or other bioactive component(s) is to be used during the brewing of an infusion beverage. The carrier should: (a) along with its hot water-extractables be safe for ingestion, (b) have a particle size similar to other components in a dry blend, (c) release most of the antioxidant (and/or other bioactive component) rapidly, (d) preferably release little if any cloudy substances into the infusion, (e) be substantially non-hygroscopic, and (f) be cost-effective.

One very useful carrier material that Applicant has found is prepared from corn cobs. It is a cost-effective particulate material known as 2040 Grit-O'Cob (produced by and obtained from The Andersons, Inc., Maumee, Ohio). More specifically, it is prepared from the crushed, milled, and sieved woody ring portion of the corncob. The above-described ActiVin® grape seed extract is efficiently absorbed and easily dried in the 2040 corncob particles, and the particles in turn, rapidly release the grape seed extract into hot water during brewing of an infusion. The corn cob particles themselves maintain their integrity in hot water and contribute little if anything visible when placed in a tea bag and brewed alone in hot water. The 2040 corn cob particles are sieved during production (20 to 40 mesh size), and are of an appropriate size match to remain mixed with typical tea particles (R. C. Bigelow Inc., Fairfield, Conn.) used for filling tea bags. That is, the 2040 particle size that ranges between approximately 0.42 and 0.84 mm in diameter falls within the typical size range for such tea particles.

Applicant has determined that the above-described 2040 corn cob material conveniently absorbs about two or three times or more of its weight of grape seed extract solution. These saturated particles are easily vacuum-dried or oven-dried at 100° C. During immersion in hot water, the major portion of absorbed and dried grape seed extract is released rapidly. For example, 250 mg of liquid grape seed extract containing 50 mg ActiVin® solids was absorbed and fully dried in 125 mg of the 2040 corn cob particles. These dried particles were then placed in a tea bag within a beaker, and 8 oz of water heated to 90° C. was added. Over 90% of the extract was released from the cob material into the water during a 4 minute tea brewing cycle. The bland corn cob particles had essentially no effect on the color and flavor of the tea.

Processed corncob particulate material has been used as an absorbent carrier for industrial pesticides, as an absorbent material in kitty litter, as an oil absorbent used with oil spills, and even as an ingredient in animal feeds. However, Applicant is unaware of any prior use of processed corn cob material in which corncob particles are supplemented with a nutrient, antioxidant, vitamin or the like for animal or human nutritional use, but where the corncob particles are not ingested. As described in the present invention, a nutrient carried in corncob particles is briefly extracted into an infusion beverage, and the nutrient ingested without the corncob. By contrast, the prior art use of corn cob material as a carrier for livestock nutrients employs vitamins and the like that have been incorporated into the cob material and that are subjected to an animal's stomach acid, digestive juices, enzymes and mechanical mixing in the gastrointestinal tract. A number of hours are available for nutrients carried in the cob material to be released and absorbed into the bloodstream.

In the present invention, however, while corn cob particles function as a carrier material for an edible substance, e.g., antioxidants, the corn cob material rapidly releases a bioactive component, e.g., nutritional substance, into an infusion and not a digestive system, and must complete this release into water in only a few minutes rather than over several hours with the help of a digestive system.

Since woody corn cob particles are a solid cellulosic material, they are easily retained by filtration (e.g., in a tea bag or by a coffee filter) and, although harmless, they need not be swallowed. Extensive chemical testing and analysis provided by the supplier has shown that the corn cob material is essentially free of any toxic or otherwise undesirable contaminants including pesticide residues, heavy metals, and microbial contaminants. For assuring absolute sterility, corn cob particulates can be baked or alternatively gamma-irradiated after packaging in bags holding up to 50 pounds or more of material. A DNA analysis of Grit O'Cob® provided by The Andersons, Inc. (Maumee, Ohio) and GeneScan USA, Inc. (Metaire, Lo.) has demonstrated that the corn cob product also exceeds European (EU) standards for being essentially free of prohibited species of genetically modified corn. While technically not listed either as a food or beverage ingredient or as an ingredient approved for direct food contact, Applicant points out that corn cobs are commonly ingested by people eating whole “baby corn” (an Asian food ingredient) and by people eating fresh corn-on-the-cob in which cob ends are frequently chewed up and swallowed.

Searching the U.S. Patent data base for the combination of keywords beverage$ and corncob$ and (absorb$ or release$), Frazier in U.S. Pat. No. 6,270,822 describes the use of a cellulosic material such as corncob to reduce the amount of chlorine in chlorinated potable water. No references have been found in which corncob has been used to deliver an ingredient into an infusion or other beverage, e.g., a micronutrient such as a mixture of antioxidants, an omega-3 fatty acid, a vitamin mixture or an aromatic flavoring ingredient.

### Grape Seed Extracts.

Applicant has determined that purified phenolic antioxidant extracts derived from fruit and vegetable materials are generally available either as liquid concentrates or as spray-dried powders. Applicant has obtained several purified antioxidant extracts that are water-soluble and free of material that would cause turbidity or clouding in a beverage. A Concord grape pomace extract was obtained from Fruit Smart, Inc. (Prosser, Wash.). It is a 68 Brix viscous and intensely purple liquid containing approximately 10% by weight polyphenolics. Another extract known as ActiVin® (San Joaquin Valley Concentrates, Inc., Fresno, Calif.) is a spray-dried water-soluble powder derived from viniferous grape seeds. It can be added to a hot or cold beverage and fully dissolves in an aqueous medium to produce a reddish-brown but clear solution. The ActiVin® extract powder consists of very small particles having a mean diameter of approximately 50 microns, and can be conveniently used for preparing a ready-to-drink beverage. However, ActiVin® and other finely powdered antioxidant extracts tend to settle and separate after blending them with larger particulate material (typically 0.5 mm-1 mm particle size) found in dry teas. This settling complicates the production of homogeneous or uniform blends of antioxidant and dry herbal teas and/or coffee beans.

In collaboration with a commercial tea blending and packaging company (Harney and Sons Tea Corporation, LLC Millerton, N.Y.), Applicant tried using alternative methods for combining ActiVin® powder with dry tea leaves in a proportion of 50-100 mg powder per 2 g dry tea per tea bag. Initially ActiVin® and tea leaves were tumbled together, but, as expected, the ActiVin® powder tended to undesirably sift apart and separate from the other tea material. Subsequently, Applicant found a means for improving the binding of ActiVin® powder to tea leaves, first by blending and pre-milling the ActiVin® with 50% by weight amorphous silica (Cab-o-Sil® M5, Cabot Corp., Billerica, Mass.) before combining it with the tea leaves. While this method was partially successful, a sufficient amount of free ActiVin® powder was still released from the dry tea, causing interference with the optical monitoring devices within the tea bag filling equipment. Consequently, other means were sought for combining ActiVin® extract with dry tea leaves. For example, moisture was gradually introduced into dry tea leaves before adding ActiVin® powder to the leaves. When the level of moisture was sufficient to bind the powder to the leaves, the leaves also undesirably adhered to one another, while the powder acted as an adhesive-like agent.

To circumvent the above problems, a different particulate form of phenolic antioxidant extract material has been produced to enrich dry tea, coffee beans and the like, and that can also be brewed with hot water to provide infusions that contain a reproducible amount of phenolic antioxidant. In one configuration, Applicant has prepared dried film materials from phenolic antioxidant liquid concentrates. Conventional freeze-dryers and heated drum dryers (commonly used to produce dried potato flakes) were used to form dried films of phenolic antioxidants. Thus, liquid ActiVin® grape seed extract from San Joaquin Valley Concentrates, Inc., (Fresno, Calif.) was used to produce dried film from the same liquid concentrate used to prepare ActiVin® powder. The dried film was subsequently fragmented to pass through a mesh sizing screen to provide antioxidant extract “flakes” whose size approximately matches that of dry tea particles packaged in conventional tea bags. For example, 90-95% or more by weight of said solids pass through a 18 mesh screen sieve (1.0 mm sieve opening) while being held back by a 40 mesh screen sieve (0.42 mm sieve opening). Thus, most flakes were configured and sized to be between approximately 0.4 and 1.0 mm in size. These antioxidant extract flakes were subsequently blended with a variety of herbal teas, and showed little if any tendency to settle or separate from the tea leaves. This “flake” approach and resulting particulate materials for phenolic antioxidants and other bioactive components which can be formed into films are also part of the present invention.

A still different “macroparticulate” form of phenolic antioxidant extract material has been prepared by combining a sprayed solution of aqueous starch with 50 micron diameter microparticulate ActiVin® extract beads to cause agglomeration of the beads. When an effective amount of the starch solution in the form of a fine spray is introduced into the ActiVin® powder that is being tumbled or contained in a fluidized bed, the starch causes the agglomeration of many hundreds or even thousands of the powder microparticles. The agglomerated material is then dried and sieved (see above) to obtain macroparticles having a dimension of between approximately 0.4 and 1.0 mm in size. Such an agglomeration approach for phenolic antioxidants and other bioactive components are also part of the present invention.

A yet different method for combining antioxidant extract with tea leaf particles involves preparing a concentrated solution of ActiVin® dissolved in ethyl alcohol, e.g., 190 proof “organic certified” grain alcohol. Applicant discovered that as much as 25% or even 50% by weight of ActiVin® can be dissolved in 190 proof alcohol without excessive solution viscosity being developed. Thus, for example, a concentrated ethanolic solution of 50% by weight ActiVin® was sprayed onto tea leaves and coffee beans during tumbling. The alcohol was evaporated using either a steady flow of air or vacuum-drying. The latter allows condensation of the alcohol vapor and recycling. Thus, an alcohol-solubilized ActiVin® solution can be sprayed onto composite herbal tea blends, or alternatively, spray-coated onto any of the constituents of an herbal tea blend, e.g., onto crushed rose hips or hibiscus, for example. Such coating of particulate solids using alcohol-solubilized phenolic antioxidants and/or other bioactive components constitute additional embodiments of the invention.

With yet another approach for introducing antioxidant extracts into herbal teas, alcohol-solubilized ActiVin® powder has been flood-coated onto paper tea bag material and dried, much like applying printing ink to paper. Herbal teas were heat-sealed inside such antioxidant-coated tea bags and brewed in hot water, during which ActiVin® on the tea bag rapidly dissolved into the tea. Preparing almost any heated beverage, e.g., herbal teas, Camellia sinensis-based regular teas, coffees and cocoa, will allow rapid solubilization of such polyphenolic antioxidants. Such coating of tea bags or other filter material for enclosing particulate solids with phenolic antioxidants and/or other bioactive components provide further embodiments of the invention.

### Grape Seed Flour.

Phenolic antioxidants and/or other bioactive components used in the present invention need not be provided in highly purified form, e.g., as extracts. For example, Applicant has found at least one cost-effective alternative to the use of purified grape seed extract for supplementing infusion beverages with PA antioxidants. In one embodiment, finely milled grape seed flours, e.g., 100-150 mesh flours, were produced from dried cold-pressed viniferous grape seeds, e.g., Chardonnay or White Riesling grape seeds. Such flours have been added to infusion beverage-producing vegetable solids, e.g., tea leaves, so that the phenolic antioxidants contained therein could be co-extracted with hot water and released into the beverage along with flavors. Applicant has measured the levels of water-soluble phenolic antioxidants in such grape seed flours. They contain as much as 10% by weight phenolics (quantitated as gallic acid equivalents), depending upon the variety of grape seed and whether the seeds have been subjected to fermentation or not.

For preparing dry tea blends for subsequent brewing in hot water, mixtures of grape seed flour and tea leaves were sealed in tea bags. Similarly, ground coffee beans and cocoa have been enriched with grape seed flour and brewed with hot water. Grape seed flour has also been added to vegetable, chicken and beef stocks so that the micronutrients including the phenolic antioxidants would be similarly extracted into these liquids when heated. Applicant has determined that between 2 and 5 minutes steeping of grape seed flour in hot water or other aqueous medium (initially heated to approximately 85±15° C.) is sufficient to release at least 80% of the flour's water-soluble antioxidants.

Besides differing in flavor, many herbal teas differ from traditional Camellia-based teas in lacking substantial levels of catechins and other types of phenolic antioxidants. Accordingly, Applicant has proposed that fortifying herbal teas with Camellia tea extracts containing the catechin-type antioxidants would be beneficial. However, these catechin extracts contain caffeine. Decaffeination is possible but adds further cost while altering flavor. As an alternative strategy, Applicant identified grape seeds that have the advantage of being inexpensive because they are a by-product of juice and wine making. As taught herein, suitably selected and fragmented or comminuted grape seeds as well as suitably modified grape seed extracts can be used to enrich hot water infusion beverages such as teas and coffees with substantial levels of beneficial PAs.

Research into the metabolism of polyphenolic antioxidants suggests that catabolism of PAs in mammals can produce bioactive products that are absorbed into the bloodstream, and that furthermore, may be as effective as the bioactive agents derived from the catechins. More specifically, microfloral catabolism of PAs in humans, produces antioxidant catabolites that may be similar to those from catechin catabolism [Deprez et al., Journal of Nutrition, 130:2733-2738(2000)]. Applicant believes that the health benefits derived from ingesting grape seed extracts, grape seed flour and other fruit PAs may be as beneficial, or even more beneficial, than those derived from drinking regular Camellia teas. Furthermore, the fruit-derived antioxidants have the advantage of being caffeine-free.

### Use of Comminuted Grape Seeds.

While the purified grape seed extracts described above tend to be relatively costly, grape seeds and their by-products are relatively inexpensive. In particular, a pressed cake from grape seeds is readily available as a by-product from cold-pressing the seeds to make grape seed oil. This pressed cake can readily be comminuted, i.e., broken into particles or finely milled to produce grape seed flour. Use of such flours is described below.

Several different forms of comminuted grape seeds were used to introduce phenolic antioxidants into herbal tea beverages. More specifically, between 0.2 g and 1.0 g of crushed grape seeds (with broken seed coats), and similar amounts of coarse (40 mesh) and more finely-milled (60 mesh) grape seed flour (collectively termed “comminuted grape seeds”) were separately mixed with 2.0 g of a dry herbal tea blend, and placed in individual tea bags. By combining up to 1.0 g of comminuted grape seeds with these teas, the resulting teas (brewed 5 minutes with 8 oz hot water at 90° C.) contained up to 100 mg of grape seed-derived polyphenolic antioxidants (measured as gallic acid equivalents). The teas had good to excellent taste properties. That is, the grape seeds introduced a very mild fruit flavor note to the tea, with no excess astringency. However, the resulting teas became milky or cloudy-looking during steeping regardless of whether crushed grape seed or grape seed flour was used. This undesirable cloudiness was traced to the release of very small particulate material or a precipitate from the broken grape seeds that passed through the pores of the tea bags and remained suspended in the tea. The chemical identity of this whitish material has not been established. One possibility considered was that soluble proteins present in grape seeds might react with soluble polyphenols to form a precipitate.

Surprisingly however, it was found that such cloudiness appearing in the grape seed infusion could be substantially reduced by milling the grape seed flour to a smaller particle size, e.g., smaller than 60 mesh. For example, when the flour was milled to a mesh size smaller than 80 mesh, such as100 mesh (0.006 inch or 150 microns), or more preferably 140 mesh or smaller (0.004 inch or 100 microns), very little clouding appeared (see below). Thus, while 40 and 60 mesh grape seed flour from White Riesling grapes produced substantial clouding during steeping of the flour at 90° C., the smaller 100 mesh and 140 mesh flour particles did not. The 140 mesh grape seed flour material was provided by San Joaquin Valley Concentrates (Fresno, Calif.) and was produced from dried fresh grape seeds (recovered from cold-pressed grapes). The grape seeds had been cleaned and dried to a moisture level of less than 10%, then mechanically pressed to release their oil, and the resulting pressed seed cake subjected to milling (e.g., air classification milling) during which the grape seed flour was maintained at a controlled temperature of less than 60 degrees C. to protect the phenolic antioxidant from premature oxidation.

It is interesting to point out that when phenolic antioxidants are released from grape seed flour into an infusion beverage or a processed food, the insoluble flour may be either discarded or ingested depending upon the food application. For example, if grape seed flour is used in a sauce or soup rather than in a tea bag, the grape seed flour material will be ingested rather than discarded. Ingested grape seed flour is beneficial since it provides a substantial level, e.g., 50-60% by weight, of beneficial dietary fiber.

### Bioactive Component Particle Agglomeration.

To improve the mechanical handling of bioactive components (e.g., grape seed flour, grape seed extract, vitamins, amino acids and other components) that are to be substantially distributed throughout fruit and/or vegetable-derived particulate solids that provide flavor in an infusion beverage, these bioactive components can be beneficially agglomerated or granulated. That is, microparticles of bioactive component-containing materials (e.g., microparticles of grape seed flour, dried grape seed extract, vitamins, amino acids and/or other bioactive components) are cohered or converted (e.g., using heat and/or pressure and/or binders) to larger conglomerate particles (also referred to as agglomerates or agglomerate particles), e.g., ranging between approximately 0.2 mm and 2 mm diameter based upon sieving. The final particle size can be selected to be similar to that of the particulate dry tea, ground coffee or other infusion-producing ingredients.

In one example of an agglomeration/granulation process, grape seed flour or grape seed extract is combined with a suitable amount of one or more edible binder agents with optional moisture, and compressed between rollers and extruded as a sheet. The extruded sheet is subsequently fragmented and sieved to obtain a desired particle size as described above for the grape seed extracts. The binder agent, e.g., maltodextrin, soluble corn starch, potato starch or a sugar syrup such as molasses, is added to mechanically strengthen the conglomerate particles. A small amount of a material such as edible fat or vegetable oil can also be added to improve the lubricity or mechanical handling properties of the agglomerated or granulated material. Use of binder agents and a variety of other methods are well known in the field of food and pharmaceutical product granulation. These methods can be employed to produce conglomerate particulate material containing at least one bioactive component that is released into an infusion beverage. The conglomerate particles possess adequate mechanical integrity yet disintegrate relatively quickly in hot water during steeping of a beverage, thereby allowing rapid release of polyphenolic antioxidants into hot water infusions.

Extraction of Phenolic Antioxidants from Whole Versus Broken Grape Seeds

A variety of extraction methods have been described for preparing concentrated proanthocyandidin-containing extracts from grape seeds. Organic solvents including primary alcohols acetone and acetates have been cited in the literature as being highly effective polyphenolic extraction solvents. However, it is highly desirable to use water rather than organic solvents for the antioxidant extraction process. In U.S. Pat. No. 6,544,581 Shrikhande et al. describe a hot water process that includes extracting whole grape seeds with hot water at 140-212° F. for about 1-6 hours, and subjecting the extract to a dual pH treatment before using a series of additional treatments to purify and concentrate the antioxidant extract. Given this extended 1-6 hour time interval for aqueous extraction of grape seed antioxidants, it would not be practical to apply this extraction method to the brewing of teas in only 3 or 4 minutes. Similarly, it would not be feasible to combine the method of Ochiai et al. described in U.S. patent application Ser. No. 11/246,442 (Pub. No. 2006/0153957) for extracting grape seed polyphenolics with the brewing of beverages in the present invention.

Notwithstanding the complexity of the above methods, Applicant has found that by cracking the grape seed coat (either dry or rehydrated seeds), the polyphenolic antioxidants within the grape seed become remarkably susceptible to rapid hot water extraction. In fact, the time differential for extraction is dramatic, with polyphenolics becoming approximately ten to twenty-fold more accessible to hot water extraction after the seed coat has been broken (see below). This discovery allows fractured grape seeds such as viniferous grape seeds, that are an abundant and inexpensive fruit by-product, to be used for augmenting antioxidant levels in foods and beverages, including infusion-type beverages that are often brewed using hot water at 75-95° C. for no more than 2-5 minutes.

Accordingly in the present invention, rather than using intact grape seeds that are slow to release their antioxidants, a soluble grape seed extract, or broken grape seeds, or a grape seed flour (as a powder or in granulated or tablet form), can be used to fortify teas, coffees, other hot water infusions and processed aqueous foods. Cold ready-to-drink beverages can be similarly fortified with polyphenolic antioxidants. In the case of hot water infusion beverages such as teas and coffees prepared from polyphenolic antioxidant-coated tea leaves or whole or ground coffee beans, the beverages become rapidly enriched with the water-soluble polyphenolic antioxidants (i.e., within seconds or minutes). For example, ground grape seed flour (e.g., 40-100 mesh material) can release antioxidant rapidly into hot water infusions typically within 2-4 minutes while grape seed extract that has been dried onto tea leaves dissolves in hot water in less than one minute.

For preparing loose teas or those packaged in conventional tea bags, solubilized ActiVin® grape seed extract can be spray-applied to tea leaves as described above. Alternatively, fractured and coarsely broken 20-40 mesh grape seed fragments may be combined with other dried tea ingredients. The latter may produce teas with some degree of cloudiness. However as described earlier, when grape seeds are very finely milled (e.g., 140 mesh particle size), tea cloudiness can be greatly diminished. It is interesting to note that broken viniferous grape seeds recovered from non-fermented crushed grapes (e.g., Chardonnay and White Riesling grapes) can release as much as 10% by weight polyphenolic antioxidants brewed in hot water, e.g., (140-212° F. or 60-100° C.). While such broken seeds tend to release a cloudy suspension of very fine insoluble material during brewing in hot water, as pointed out above, if the grape seeds are first milled to a very fine flour (e.g., 140 mesh flour), the same amount of grape seed material brewed under similar conditions tends to produce a substantially clear tea.

### Grape Seed Breakage Allows Release of Polyphenolics Antioxidants.

The effect of breakage and/or crushing of grape seeds on their release of endogenous antioxidants into a hot water infusion such as tea has been investigated herein. Small batches of dried whole White Riesling grape seeds (ranging from 10 seeds weighing approximately 0.25 g to 80 seeds weighing 2.0 g) were positioned between aluminum blocks, and a fixed 160 pound force was applied to the blocks for 15 seconds. This force generated between approximately 2 lb and about 16 lb pressure per grape seed (each measuring approximately 1/10 inch in diameter), or a maximum pressure of about 2000 psi. Multiple batches of seeds were crushed so as to obtain sufficient material for hot water extraction testing. Applicant observed only intermittent and partial grape seed breakage when 2 lb force was applied per seed. Breakage was more thorough and visible in most seeds when 4 lb force per seed was applied. With 8 and 16 lb force per grape seed, all seeds appeared crushed, with the seeds being reduced to approximately ½ their original thickness at 16 lb (0.10 inch thick seeds crushed to a layer approximately 0.050 inch thick). Machine-rolled fully crushed seeds were also prepared as a reference material. The latter material was reduced to a small particle size and sieved (mostly 0.020 inch and smaller), and provided a comparison and indication of antioxidant release when the seeds were thusly treated. Two gram quantities of the various samples of crushed seeds were placed in 200 ml volumes of freshly boiled water (95° C.) in glass beakers. The seeds were extracted for 4 minutes with gentle stirring (78° C. after 4 min). One milliliter samples of the extract were then removed and centrifuged to provide clear supernatants for assay of hot water-solubilized polyphenolics. Five microliter sample volumes were assayed using the standard Folin-Ciocalteau (F-C) colorimetric assay (see below). Weight percentage concentrations of phenolics (expressed as an equivalent weight percent gallic acid) present in the seeds and released into the hot water were calculated by comparison to a 0.1% by weight gallic acid standard solution (see Table 1).

The results in Table 1 indicate that with unbroken seeds, only about 6% of the ultimate antioxidant level obtained from fully crushed seeds was released during 4 minutes brewing in the hot water. With moderate breakage force (4 pounds per seed), the yield of phenolic antioxidant (AO) increased 12-fold (76/6), and when this force was doubled to 8 pounds, 90% of the ultimate antioxidant level of 7.5% was released.

TABLE 1

| Force (lb per Grape Seed) | Phenolics (wt % GAE) | Relative Yield AO |
|---|---|---|
| Zero (unbroken) | 0.43 | 6 |
| 2.0 | 2.27 | 30 |
| 4.0 | 5.71 | 76 |
| 8.0 | 6.72 | 90 |
| 16.0 | 7.26 | 97 |
| machine-crushed | 7.50 | 100 |

Polyphenolic Antioxidant is Released Rapidly into Hot Water from Broken Grape Seed.

The release of phenolic antioxidants into 200 g freshly boiled water held in a Pyrex beaker, from 2.0 g partially broken dried White Riesling grape seeds (crushing force of 4 lb per seed, see above) was monitored over a 10 minute incubation/extraction period. The temperature of the water decreased during extraction, from 95° C. at time zero to 78° C. at 4 min to 68° C. at 8 min. Aqueous samples were removed every two minutes during the incubation, and centrifuged for assay of the soluble phenolics (see above). The data provided in Table 2 indicate that water-soluble phenolic antioxidants from broken grape seeds are released very rapidly into the surrounding hot water. After 4 minutes incubation, approximately 86% of the total amount of antioxidants (released by 8-10 minutes) has already been released. Within 6 minutes incubation, very little additional antioxidant is released.

TABLE 2

| Extraction Time (min) | Phenolics (wt % GAE) | Relative % Yield AO |
|---|---|---|
| 2 | 4.04 | 67 |
| 4 | 5.22 | 86 |
| 6 | 5.83 | 96 |
| 8 | 6.02 | 100 |
| 10 | 6.05 | 100 |

Thus, from the data in Tables 1 and 2 it is apparent that cracked grape seeds are effective in releasing the majority of their total available hot water-soluble phenolic antioxidants over a very short time period (i.e., 4-5 minutes incubation in water that has just been boiled). Accordingly, broken grape seeds are a useful antioxidant source for addition to infusion materials including dry herbal teas, Camellia-based tea leaves, ground coffee beans and the like, and can provide substantial amounts of water-soluble PA-type antioxidants in these hot water infusion beverages.

Fortifying Herbal Teas with Grape Seed Flour Proanthocyanidin Antioxidants.

A variety of viniferous grape seeds including Merlot, Chardonnay, Riesling and Concord were obtained by Fruit Smart, Inc. (Prosser, Wash.), and these clean dried seeds were pressed to recover their endogenous edible oils. The resulting pressed seed cakes were ground into progressively finer flours (increasing mesh number), i.e., 40, 60, 70 and 100 mesh. Applicant measured the relative levels of soluble phenolic antioxidants released from several of these flours after 4 minutes incubation in hot water (2.5% by weight flour suspended in 80-90° C. water). The F-C assay was used to measure phenolic levels in the clear aqueous portion (supernatants) following centrifugation of the incubated flour-water mixtures. The extractable phenolic level in the flour was calculated by multiplying the extract's colorimetric measurement (optical density at 760 nm) for the 2.5% flour suspension by 40 and dividing by the measurement for a 0.1% by weight gallic acid standard. From the data in Table 3 it is apparent that for a given variety of grape seed, the flour particle mesh size had a relatively small effect on extractable phenolics. However, large differences were observed among the varieties of grape seed. In particular, Riesling and Chardonnay grape seed flour contained 4-5-fold more antioxidant than Concord and Merlot flours. A probable explanation for the lower level in Concord seeds is that commercial enzyme treatment and hot-pressing of the grapes (for maximizing fruit juice recovery before recovery of the seeds) results in substantial loss of phenolics from the seeds. In the case of Merlot seeds, the Merlot grapes are crushed and fermented 7-10 days in the initial stages of making red wine before the seeds are recovered. It is probable that leaching and loss of phenols from the seeds occurs during this fermentation.

By contrast, the Chardonnay and White Riesling grapes are cold-pressed for white wine, and the seeds are recovered promptly. Accordingly, Applicant has found that when viniferous grape seeds are harvested from cold-pressed grapes and then dried (rather than hot-pressed or fermented grapes), the seeds retain high levels of PA antioxidants.

TABLE 3

| Seed Variety | Flour Mesh Size | Phenolics (wt. % GAE) |
|---|---|---|
| Chardonnay | 60 | 8.7 |
| | 100 | 9.2 |
| White Riesling | 60 | 11.8 |
| | 100 | 10.7 |
| Concord | 40 | 2.0 |
| | 60 | 2.2 |
| Merlot | 40 | 1.8 |
| | 70 | 2.2 |

On the other hand, Applicant has determined that when grape seeds such as Chardonnay and Riesling seeds are left intact rather than being ground, they release very little of their antioxidant content. However, when these same seeds are gently broken as in Table 1, but by passage between metal rollers, much of the PA antioxidant can be released into hot water during a typical period of hot tea brewing (e.g., 4 minutes in 80-90° C. water).

Clear Versus Cloudy Tea Infusions Produced with Broken Grape Seeds.

Comminuted grape seeds, and more finely divided grape seed flours may also be useful in freshly brewed teas (e.g., in tea bags), providing that the seeds and flours do not generate an excessive amount of micro-particulate material that could cause turbidity (clouding) or milkiness in the tea. Depending upon processing conditions, gently broken grape seeds appear to produce less milkiness during hot water brewing of teas than more aggressively broken or pulverized material. In fact, Applicant has discovered that whole dried grape seeds containing approximately 10% or less by weight water can be rehydrated by incubating the seeds for several hours at room temperature (or at higher or lower temperatures) with approximately 35%-40% by weight water. After this rehydration, the seeds are less fragile, and may be broken open and flattened in one piece without shattering using pressure-rolling. The moist flattened seeds can be re-dried and stored for use in teas. Tea infusions produced from these roller-flattened moistened seeds (that have been re-dried) are remarkably free of the undesirable milkiness/cloudiness that is very evident when whole dried grape seeds are crushed and brewed either in loose tea or in tea bags. Therefore, the present invention provides a method in which the grape seed can be broken to release polyphenolic antioxidants into hot water while minimizing the simultaneous release of undesirable and unesthetic cloudy or milky material.

Finely divided grape seed flour can also be useful in beneficially releasing antioxidants very rapidly in hot tea infusions. While producing grape seed flour may require more processing time, and may be somewhat more costly than roller-crushed grape seed, both materials are valuable. Since finely divided grape seed flour particles may be more susceptible to oxidation in air than coarsely broken or roller-flattened grape seed, appropriate production and storage conditions should be utilized to minimize oxidation of the phenolic antioxidants. For example, a cooling process can be used to prevent heat-accelerated air oxidation. Also nitrogen gas may be used to purge or exclude oxygen during and/or after grinding of the grape seed flour.

Applicant has observed that for several varieties of mechanically de-fatted (pressed) grape seeds tested, e.g., Chardonnay and White Riesling, finer mesh size ground grape seed flours produce less milkiness and clouding than coarser flours. For example, when placed in tea bags with other dry tea ingredients, 80 and 100 mesh grape seed flours (passing through 80 and 100 mesh sieves with 0.007 and 0.006 inch openings) appeared to produce clearer hot tea infusions than 40 mesh and 60 mesh grape seed flours (passing through 40 and 60 mesh sieves with 0.017 and 0.010 inch openings). Thus, brewing approximately 1.00g of a fine 85 mesh White Riesling grape seed flour blended and placed in a tea bag together with 2.0g herbal tea [e.g., Celestial Seasonings (Boulder, Colo.) “Tension Tamer” brand tea] produced a considerably clearer tea than using either a coarser 40 mesh grape seed flour or coarsely crushed or rolled whole grape seed in the same tea.

### Minimizing Tea Clouding Using Fine Mesh Grape Seed Flours.

The reduction in clouding of hot teas and other beverages achieved with the use of finer mesh grape seed flours is illustrated herein. To quantitate the amount of clouding contributed by grape seed flour, the increase in Optical Density (O.D.) measured in a spectrophotometer at a wavelength of 650 nm was compared for tea infusion beverages prepared with and without 0.5 g of grape seed flours of different mesh sizes (0.50 g grape seed flour admixed with 2.0 g dry tea inside a tea bag). While somewhat subjective, substantial clouding is noted when the O.D. 650 nm of the beverage has increased more than approximately 0.100, comparing two teas, one brewed with, and the other brewed without grape seed flour (0.50 g) according to the following regimen. Preferably, the above increase in beverage O.D. 650 nm is limited to 0.050 or less. Tea infusions were brewed for 5 minutes using 200 g hot water contained in a glass beaker at an initial temperature of 90° C. Approximately 0.5 g of grape seed flour (or alternatively 50 mg grape seed extract) was admixed with approximately 2 g tea leaves (Lipton “100% Natural Tea”) and placed in each tea bag. As shown below in Table 4, comminuted grape seeds that are milled to flours finer than 60 mesh, and preferably finer than 80 or 100 mesh, can be used to prepare tea infusions that exhibit minimal clouding.

TABLE 4

| Mesh Size | Flour Particle Size (mm) | Clouding (O.D. 650 nm) |
|---|---|---|
| 40 | 0.42 | 0.118 |
| 60 | 0.25 | 0.139 |
| 100 | 0.15 | 0.028 |
| 140 | 0.11 | 0.017 |

Thus there are significant advantages in using finely ground grape seed flour rather than coarsely broken grape seeds (improved clarity of heated aqueous infusions and rapid release of polyphenolics).

Notwithstanding the above results, Applicant has found that the same fine mesh grape seed flours are difficult to mix, commingle and maintain in uniform mixture with larger particles of dry herbal tea ingredients, for example. Therefore, agglomeration, e.g., granulation, was used to convert the fine flour into larger particles that would remain uniformly mixed with similarly sized material. Such granulation successfully prevented the flour from sifting and separating away from the coarser material. Accordingly, granulation is used to form larger conglomerate particles of controlled sizes from fine flours, and facilitates the apportioning and mixing of grape seed flour with larger particles of other food materials such as herbal tea ingredients. The granulation process can be carried out using pressure alone to cause compaction of grape seed flour into larger particles. Alternatively, moisture and/or food adhesives, e.g., starch and vegetable gums, may be used as binding agents to facilitate the cohesion of grape seed flour particles to form conglomerates.

For use in the present invention, these binding agents are selected and used in amounts that allow the conglomerates to rapidly disintegrate when exposed to hot water. Thus, when brewed in a tea bag in hot water, conglomerates of granulated grape seed flour rapidly fall apart, thereby allowing efficient extraction and liberation of polyphenolic antioxidants from the fine flour particles within minutes (see Table 3).

Selection of tea bag materials that have small pore sizes can also be used to partially control the amount of small particulate material that escapes through the wall of the tea bag and into the tea. For example, tea bags are often formed from non-woven materials whose effective pore size may be reduced by utilizing a heavier basis weight (i.e., thicker) material. Thus, Ahlstrom, Inc. (Windsor Locks, Conn.) produces heat-sealable non-woven tea bag material #11697 with a 24 gsm (grams per square meter) basis weight that retains more fine particulates than #11557 with a basis weight of only 16.5 gsm.

If a clear (non-cloudy), fully water-soluble beverage formulation is required (e.g., an “instant powdered tea” or “instant coffee” such a product may be formulated using water-soluble ingredients that are supplemented with a water-dispersible (e.g., water-soluble) dried grape seed extract. Alternatively, herbal tea material or Camellia tea leaves, or even ground coffee beans that are not themselves water-soluble can be combined with, or even coated by a grape seed extract in a manner that allows the extract to fully disperse (e.g., dissolve) in hot water at the same time that the tea material or coffee beans are steeping in hot water to release their flavors. For example, Applicant has dissolved 25%-50% by weight grape seed extract powder (see below) in 50-75% by weight of 190 proof (95%) natural grain alcohol. These ethanolic solutions have been either spray-applied or tumbled with various tea materials and coffee beans. The adhered solutions were then dried on the tea or coffee beans and stored until used. When the dried, extract-coated/ground coffee beans or the coated tea material (in a tea bag) were steeped in hot water, e.g., at 190° F., the grape seed extract rapidly dissolved to provide colored but clear beverages. Measuring the increased phenolic antioxidant levels in such teas (as gallic acid equivalents) confirmed that the added grape seed extract had fully re-dissolved during steeping of the teas in heated water.

Water and alcohol-soluble grape seed extract described above is commercially available, and one such extract contains approximately 90-95% by weight of phenolic antioxidants. Such grape seed extracts and other fruit and vegetable polyphenolic extracts can be considerably more costly than the precursor grape seeds for providing a specified amount of phenolic antioxidant (e.g., ActiVin® grape seed extract from San Joaquin Valley Concentrates, Fresno, Calif. costing approximately $90-$100 per kg,). As indicated above, following passage through the human digestive system, grape seed extracts may provide health benefits very similar to those provided by the catechins found in regular Camellia teas such as green, black, oolong and white teas.

Yield of Polyphenolics Antioxidants from Intact Grape Seeds, Grape Seed Flour and Broken Seeds.

As indicated above, unbroken grape seeds are remarkably poor in releasing polyphenolic antioxidants into hot brewed tea. When intact White Riesling grape seeds were brewed for 4 min and 8 min in water at 80-90° C., their release of endogenous phenolics was limited to only 0.43% and 1.0% by weight phenolics respectively, as gallic acid equivalents (GAE). This level is 10 to 20-fold lower than with the corresponding broken seeds. Similarly, with intact dried grape seeds from cold-pressed Chardonnay grapes, the seeds released 18-20-fold lower levels of phenolics than corresponding broken seeds. Applicant has determined that after dried grape seeds from cold-pressed White Riesling grapes have been ground into 60 and 100 mesh flours, they release between 10.7% and 11.8% by weight GAE when extracted in freshly boiled water. When these same seeds were more gently broken by crushing them between two metal plates (applying approximately 8 pounds force per grape seed as described above) and then brewing the seeds 4 min and 8 min in water at 80-90° C., the broken seeds were still able to release substantial levels of phenolics (8.4% and 9.5% by weight GAE respectively).

In summary, crushed/coarsely broken grape seeds, but not the intact seeds are capable of rapidly releasing high levels of phenolic antioxidants into hot brewed teas. Judging from the above data, it is estimated that with 4 minutes of tea brewing (water at 80-90° C.), approximately 70-80% of the available water-soluble phenolic antioxidants in coarsely broken grape seeds are released into the tea. Further reduction in grape seed particle size (e.g., into grape seed flour) is not merited based upon the small incremental release of phenolics. As pointed out above, grinding grape seeds in flour may complicate the use of the material in brewed teas, as well as decreasing the shelf life stability of polyphenolic antioxidants.

Yield of Grape Seed Polyphenolics Antioxidants from Hot-Pressed, Fermented, and Cold-Pressed Grapes.

The level of polyphenolic antioxidants found in different grape seeds was shown to vary dramatically depending upon the treatment of the crushed grape prior to recovering the seeds (Table 3). Thus, grape seeds harvested from grapes that had been either fermented (Merlot) or hot-pressed and enzyme-treated for maximizing the yield of grape juice (Concord) contained far less antioxidant (about 4-5-fold) than grape seeds from cold-pressed Chardonnay and White Riesling grapes used for making white wine.

Enhanced Flavor of Herbal Teas with Crushed Cold-Pressed Grape Seeds.

As shown above, crushed grape seeds from cold-pressed grapes can provide high levels of polyphenolic antioxidants in hot brewed teas. Accordingly, crushed viniferous grape seeds from cold-pressed Chardonnay and Riesling grapes containing high levels of polyphenolic antioxidants (in which the PAs represent a major class) were added to a variety of dry herbal teas. The broken viniferous grape seeds (typically 0.5 g to 1.0 g) were blended with approximately 2 g of herbal teas that were placed in single tea bags, and then brewed in 8 oz. (240 g) hot water for 4 minutes. Surprisingly, in addition to substantially increasing the phenolic level, the brewed grape seeds with their mild astringency were found to beneficially accent herbal tea flavors without substantially altering their inherent flavor profiles. Such flavor enhancement or accenting is also an aspect of the present invention.

### Proanthocyanidin Antioxidant Biofunctionality.

PA molecules are oligomers and polymers built up from catechin-type subunits. It is not generally appreciated by skilled formulators or processed foods and beverages that PA antioxidants in particular, are metabolized by the microflora in the human digestive system to bioactive products similar to the metabolites of catechin antioxidant monomers found in Camellia teas. It is proposed that when PAs are added to herbal teas, they can biofunctionally substitute for the catechins found in regular Camellia sinensis teas without introducing undesirable caffeine. To Applicant's knowledge, this concept has not been appreciated in the prior art food and beverage literature.

More specifically, the present invention describes practical and cost-effective means for fortifying dry herbal teas and the resulting brewed beverages with PAs. According to the present invention, dry teas (loose or packaged in tea bags) are supplemented with broken (e.g., crushed or flaked) grape seeds that contain approximately 10% or more by weight of polyphenolic antioxidants (based upon gallic acid equivalent units or GAE). Thus, adding one gram of these seeds to an herbal mixture can potentially release 100 mg or more of these phenolic antioxidants that are beneficial to ones health.

### Use of Polyphenolics Antioxidant-Containing Grape Seeds as Carriers for Essential Oils Used as Tea Flavoring Agents.

The process of herbal tea blending and flavoring includes careful selection of essential oils that are added in small amounts to dried herbal tea ingredients. For such dry teas to possess adequate shelf life, it is important that added essential oils possess adequate flavor stability. Accordingly, it is important that the oils are neither excessively volatile nor excessively susceptible to oxidation in air. For improved flavor stability, Applicant has discovered that broken grape seeds, in addition to being useful for supplementing teas with polyphenolic antioxidants, can function as a carrier and delivery vehicle for essential flavoring oils. At least two chemical properties of grape seeds are helpful in this functional role. First, the high level of polyphenolic antioxidants in grape seeds can help stabilize constituent flavoring chemicals against oxidation. Second, dried grape seeds contain approximately 10% by weight triglyceride-based grape seed oil. This oil provides a compatible hydrophilic chemical environment where flavoring oils can apparently be sequestered until released during hot water brewing of tea.

### Tea Antioxidants.

Conventional Camellia sinensis teas such as the green and black teas are often considered superior to herbal teas because they are rich sources of the catechin family of antioxidants (hereinafter abbreviated “CA”, see details above). However, people who dislike the caffeine naturally present in Camellia teas must purchase decaffeinated varieties. In the present invention, the shortcoming of herbal teas relative to Camellia teas is overcome by adding PA, in which the health benefits of Camellia teas with CA are obtained without the caffeine of Camellia, as the PA is metabolized

The PA compounds that form the bulk of grape seed antioxidants are essentially oligomers of CA compounds, i.e., flavan-3-ol units, and form the basis of dietary supplementation with grape seed extract (GSE). GSE may also contain varying amounts of the monomeric catechin and epicatechin compounds. A number of independent lines of research evidence suggest that the PA compounds are metabolized by colonic microflora to very similar, if not the same, bioactive compounds produced from the metabolism of monomeric catechin compounds. In fact, in a research study by Deprez et al. in Journal of Nutrition, 130:2733-2738(2000) entitled “Polymeric Proanthocyanidins Are Catabolized by Human Colonic Microflora into Low-Molecular-Weight Phenolic Acids” all aromatic phenolic acids that were identified as metabolites of PA polymers, were shown to be similar to those produced by colonic microflora metabolism of either catechin or procyanidin dimer B3. In the study by Deprez et al., PA polymers that were previously considered to be inert in the digestive tract were shown to be as easily degraded as other flavonoid monomers. From this research, Applicant has concluded that for dietary supplementation and for food fortification, PA compounds can be used as a substitute for CA compounds.

More specifically, when supplementing herbal teas, PAs can be conveniently provided by grape seeds prepared in a variety of physical forms, e.g., broken, flaked or ground grape seed. By experimentation, Applicant has found that release of PA from intact dried grape seeds, e.g., Chardonnay and White Riesling, into hot water (90° C.) is very slow and inefficient. Surprisingly however, by cracking open the same grape seed (without disintegration into particles) the PA is rendered about ten-fold more accessible to extraction and dissolving in hot water (90° C.) during a 4 minute tea brewing cycle. Quantitation of the PA leached from cracked White Riesling seeds during this 4 minute 90° C. extraction showed a release of approximately 5% by weight phenolics (expressed as GAE units based upon the dry weight of the seeds). By crushing and disintegrating the same grape seed into coarse fragments, the amount of PA released during an identical 4 minute hot water extraction was approximately doubled to 10% by weight (GAE units). Other dry vegetable or fruit matter rich in PA may also be added to a tea bag or to loose tea in addition to, or in place of, grape seeds.

### Use of Alcohol and Water-Soluble Grape Seed Extracts.

Applicant has obtained water-soluble commercially prepared dried, powdered extract purified from grape seeds (e.g., Activin® produced by San Joaquin Valley Concentrates (Fresno, Calif.). This powder typically contains greater than 90% by weight phenolic antioxidants (measured as % by weight gallic acid equivalents). Although purified using an aqueous system, Applicant has found the Activin® extract to be extremely soluble in grain alcohol. While an aqueous solution of the Activin® could be used to fortify tea leaves, it is less practical and convenient than using a concentrated solution of Activin® dissolved in alcohol, e.g., 190 proof alcohol containing 95% ethanol: 5% water. The solvent portion of Activin® solution can be rapidly evaporated using ventilation, vacuum or forced air, for example. For example, Applicant has taken 2.0 g single serving quantities (single tea bag) of dry herbal teas and coated them with 50 mg Activin® dissolved in 50 or 150 mg of 190 proof alcohol, or 100 mg Activin® dissolved in 100 or 300 mg alcohol. These ethanolic solutions containing either 25% or 50% by weight dissolved Activin® were tumbled with the herbal tea leaves, allowing the teas to become partially liquid-coated. Following drying, the Activin® was observed to have coated and dried onto the tea leaves. Gentle tumbling of the dried material allowed any cohered leaves and other herbal, vegetable and fruit-type material to disaggregate. This dried material was judged suitable for use in automated packaging machinery used to fill tea bags. When tea blends are heavily coated with Activin® extract and subsequently dried, the coated tea material may even be diluted with other uncoated tea materials so as to produce blended dried teas containing whatever level of Activin® is desired in the finished product.

Still other antioxidant delivery methods can be used, including applying a PA-containing extract such as Activin® dissolved in water or alcohol onto tea bag paper filter material and evaporating the solvent. Upon brewing, the tea bag material releases the extract into the tea. Applicant has tasted increasing levels of Activin® in 8 oz servings of a variety of teas and found that 100 mg of Activin® can generally be dissolved in the teas without producing any unpleasant astringency. A useful level of Activin® in 8 oz servings of typical herbal teas ranges from approximately 25 mg to 150 mg per serving, with 50 mg to 100 mg being a preferred range. At the 200 mg per serving level and above, the antioxidant becomes undesirably astringent.

In terms of health benefits, there have been reports over the past several years that PAs and their metabolites can beneficially inhibit aromatase enzyme activity, inhibit the growth of cancer cells in cell culture, and prevent or attenuate a number of diseases in various animal models of disease, including atherosclerosis, cataract formation, and skin and breast cancer. It is anticipated that the health benefits of PA will parallel those reported for the CA family of antioxidants, given that PA has now been shown to be similarly metabolized in vivo via the digestive system's microflora.

Measurement of phenolic antioxidant levels in herbal teas was carried out using the Folin-Ciocalteau colorimetric assay (abbreviated herein “F-C assay”) as follows: Five microliters of sample solutions (or 5 and 10 microliter samples of a standard 0.100% by weight gallic acid solution) were diluted into 0.50 ml of distilled water. Fifty microliters of F-C reagent (Sigma-Aldrich, St. Louis, Mo.) were then added and mixed, and finally 0.25 ml of 15% by weight sodium carbonate solution was added (between 2 and 7 minutes later) with mixing. The resulting samples were incubated 2 hr in the dark before reading the optical absorbance at 760 nm.

The endogenous polyphenolic antioxidant level measured in most non-supplemented herbal teas using the F-C assay was minimal. After fortification, by adding 1 g broken grape seed (White Riesling) per 8 oz serving (240 ml) of tea brewed for 4 minutes, the phenolic concentration was increased as much as 100 mg GAE units per serving.

Several unanticipated laboratory findings are disclosed herein, that are expected to benefit the consumer of polyphenolic antioxidant-fortified herbal teas.
1. Grape seeds from different varietal grapes that are processed differently contain widely differing levels of phenolic antioxidants. Applicant has discovered that grape seeds from unfermented cold-pressed grapes contain much higher levels of phenolics than grape seeds purified from either grapes that have undergone fermentation in wine or grape seeds that have been heated during juice extraction. Even grape seeds from different varieties of cold-pressed grapes (e.g., White Riesling vs. Chardonnay), and presumably from different vintage years, show large differences in phenolic antioxidant levels. Therefore, grapes should be cold-pressed if their seeds are going to be broken and used for their antioxidant content. Furthermore, grape seeds from different grape varieties and vintages should be tested to select those having the highest levels of antioxidant.
2. As explained above, if time-limited water extraction of antioxidants is desirable, e.g., brewing teas of 4 minutes at 80-90° C., then broken grape seeds should be used rather than intact grape seeds.
3. Grape seeds typically contain approximately 10% by weight edible grape seed oil, and most grape seeds are harvested and pressed for their valuable oil. While the oil-depleted pressed grape seed cake still contains most of the original phenolic antioxidant content, when the pressed cake is placed in hot water, it tends to disintegrate more rapidly than native grape seed material. This disintegration releases more whitish material that diffuses through the wall material of typical tea bags to produce a cloudy and somewhat cosmetically unappealing tea. Applicant has discovered that grape seeds which have not been pressed can be broken and brewed in teas with release of substantially smaller amounts of the whitish material into the brewed tea.

One benefit of the invention is that by controlling the source and quantity of PA that is added to the herbal tea, the tea's micro-nutritional profile can be greatly improved without greatly increasing the beverage's cost. For example, if dried PA extract (Activin® reported to contain approximately 90% by weight phenolics as “gallic acid equivalent” or “GAE” units) costs $100 per kg, then if a typical supplementation includes 50-100 mg of the dried extract per serving, the cost per tea bag (per 8 oz. serving) would be between 0.5 and 1 cent. Furthermore, if grape seeds cost approximately $2.00 per kg., then supplementing a tea bag with 1 g broken grape seed would cost even less (only 0.2 cents). If the grape seeds deliver 5% by weight phenolics, then 1 g will deliver 50 mg.

### Definitions.

In the context of the present invention and the associated claims, the following terms have the following meanings:

The terms “fruit and/or vegetable-derived dry particulate solids” or alternatively “dry vegetable solids” within the context of the present invention refers to any non-toxic dried plant-derived material such as portions of dried fruits, seeds, skins, interior pulps, flowers, roots, leaves such as Camellia sinensis tea leaves, herbal tea ingredients, beans, e.g., green or roasted coffee beans, cocoa beans, processed cocoa and chocolate-containing compositions, and the like that can be used for producing an infusion-type beverage. Such plant parts particulate solids may, for example, be cut, broken, and/or ground plant parts.

In distinction from the particulate solids described above, the terms “particulate materials” and bioactive component-containing particulate materials” refer to particulates which are artificially created from materials which are selected to contain substantial amounts of one or more desired bioactive components.

As used in reference to the present invention, the terms “bioactive” and “biological activity” refer to a material having an effect on or eliciting a response from living matter, especially including living tissue of a human. Thus, the term “bioactive component” refers to a component of a composition which has biological activity and is therefore bioactive. Examples include, for example, antioxidants, vitamins, minerals, and amino acids.

The term “infusion” refers to a solution obtained by steeping or soaking a vegetable material in a liquid, typically water in order to extract desirable substances such as flavors and biochemically active agents from the material. Similarly, the term “infusion beverage” as used herein refers to any drinkable/potable water-containing liquid that is prepared by brewing a portion of dry vegetable solids in water.

The term “heated water” or “hot water” refers to water heated to a temperature of between approximately 140° F. (60° C.) and 212° F. (100° C.) to accelerate the extraction of desirable substances in the vegetable materials. Brewing, steeping or extraction is continued for a time sufficient to extract a desired amount of flavor, beneficial nutrients and/or micronutrients (including phenolic antioxidants) from vegetable solids including broken and/or milled grape seeds. For example, traditional Camellia and herbal teas are typically steeped or brewed in hot water for between 2 minutes and 10 minutes using between 1 g and 2 g of dried tea vegetable material per 6-8 ounce serving. On the other hand, coffee-type infusion beverages are typically prepared using 5-10 g of ground roasted coffee beans per 6-8 ounce serving. Hot chocolate or cocoa-type infusion beverages contain processed cocoa powder, and may contain fresh or powdered milk as well as water. Milk, cream, and other ingredients of animal origin may be added to the infusions of the present invention within the intended scope of the present invention. While the serving size may vary among different hot water infusion beverages, for the purposes of this invention, a serving size is considered to be between approximately 1 and 10 ounces. For example a shot of espresso is approximately one fluid ounce, while a serving of tea may be as large as ten fluid ounces.

The terms “fractured,” “broken” and “cracked” with regard to grape seeds refer herein to the physical processing of grape seeds in which the grape seed coat is breached and the seed is cracked or broken or crushed to varying degrees by passage through rollers or other crushing devices so as to reduce the grape seeds from a diameter of approximately 3 mm (⅛ inch) or more, to a fragment diameter or particle size of approximately 1-2 mm. The breakage of grape seeds and their outer coatings has been shown to be important in allowing phenolic antioxidants process of comminution allows phenolic antioxidants that are located within the seed coat and within the interior of the seed to be easily extracted into hot water infusions, typically within 2-5 minutes of exposure to hot water.

The terms “comminuted,” “ground” and “milled” with regard to grape seeds relate to physical processing and further reduction of grape seed particle size by mechanically crushing, grinding and/or milling that can be used to convert the grape particles into flours of varying mesh size. Broken grape seeds are typically reduced from 20 mesh to finer particle sizes of 40 mesh, 60, 80 and even 100 mesh size. Prior to comminution, grape seeds are cleaned, e.g., with water, and usually dried. Drying is required for subsequent processing (such as pressing for oil and/or grinding into flour). The drying process reduces the moisture level in the grape seeds, preferably to 10% by weight or less. Drying is important for preventing growth of molds and other microbes, as well as for mechanical processing.

Although comminuted grape seeds may be prepared from “native grape seeds” defined as grape seeds that contain their natural native level of endogenous grape seed oil (usually about 10% by weight), milled grape seed flours are usually prepared from grape seeds that have been “defatted”, i.e., treated to reduce some or even most of their oil content. Defatting may be accomplished by either mechanical or chemical means. Mechanical means (e.g., pressing of the seed) is preferred over chemical means involving treatment with an organic solvent to extract the endogenous oil. Pressing of grape seeds typically reduces grape seed oil content from its native level of approximately 7-12% by weight to 1-2% by weight. Besides yielding commercially valuable grape seed oil, the defatting process provides grape seed material that has a longer shelf life because it is less susceptible to oxidative rancidity.

The term “hot water-soluble phenolic antioxidants” as used herein refers to phenolic antioxidants that are capable of being dissolved in water at a temperature of approximately 80° C. (e.g., 70-90° C.) within a period of no more than 10 minutes. Dissolved phenolic antioxidants can be detected in an infusion beverage, and can be quantitated as gallic acid equivalents (GAE) relative to a 0.100% by weight gallic acid standard solution using the Folin-Ciocalteau colorimetric assay described herein.

The term “rapid release of phenolic antioxidants” as used herein describes the rapid solubilization of these antioxidants into an infusion beverage, regardless of whether the antioxidants are provided in particles of fruit or vegetable material (e.g., comminuted grape seeds), or in a coating or in particles of a dried extract isolated from fruit or vegetable material (e.g., ActiVin® grape seed extract particles), or in particles of a carrier material (e.g., corncob particles) that contains instilled antioxidant extract. The term “rapid” indicates that most (i.e., greater than 75% by weight) of the phenolic antioxidant provided for one serving of an infusion beverage are released into an infusion beverage in less than 10 minutes of brewing, and preferably less than 5 minutes when hot water at a temperature of between 70-90° C. is added.

Referring to grape seeds that are “provided in a physical form and in sufficient quantity to release at least 25 mg of said phenolic antioxidants per serving of said beverage during a normal time interval for brewing said beverage” describes grape seeds whose seed coatings and seed structure have been sufficiently disrupted to release a specified amount of phenolic antioxidants (e.g., between 25 mg and 100 mg) into a beverage serving (e.g., between 6 oz and 8 oz) during a normal time interval for brewing (e.g., less than 10 minutes and preferably no more than 5 minutes after hot water at a temperature of between 70-90° C. is added).

The term “substantial clouding” refers to an undesirable milkiness or visible turbidity or haze resulting from microparticulate material that is released from milled or comminuted grape seeds and/or a grape seed extract during steeping of an infusion beverage. Substantial clouding is defined as an increase in the beverage's O.D. at a wavelength of 650 nm of greater than 0.100.

The term “substantially caffeine-free” herein refers to an infusion meeting the international standard wherein at least 90% and preferably at least 99% of the endogenous caffeine originally present in coffee beans or tea leaves, for example, has been removed.

The term “cold-pressed” as used in the context of grapes herein refers to the use of ambient or sub-ambient temperatures for pressing, i.e., extracting, juice from grapes and other fruits and vegetables (e.g., olives). Applicant has found that the use of reduced juicing temperatures has been found to help retain high levels of phenolic antioxidants contained in seeds within grapes (and probably other fruits)

For the purposes herein, the concentration or “percentage by weight” of phenolic or polyphenolic antioxidant is assayed and expressed as an equivalency to a percentage by weight of gallic acid; i.e., gallic acid equivalents or GAE units that are units of concentration. These so-called phenolic or polyphenolic concentrations are measured using a colorimetric assay based upon reacting phenolic/polyphenolic compounds with Folin-Ciocalteau (abbreviated “F-C reagent”). In this assay, a gallic acid standard solution (1.00 mg/ml) is used to generate a linear standard curve. Increasing amounts of the gallic acid solution (between 2.5 and 15 μl) are diluted into a series of sample test tubes holding 0.50 ml water. Next, 50 μl of F-C reagent (Sigma Chemical Company) is added to each tube. After 1 minute, but before 8 minutes following addition of the F-C reagent, 0.25 ml of a 15% by weight aqueous sodium carbonate solution is added, the samples are vortexed, and then incubated (maintained) for 2 hours at room temperature. The optical absorbance at 760 nm is read. A sample that is constituted with all chemical components but without gallic acid is also incubated as used as a blank sample to zero the sprectrophotometer (Spectronic 20D+manufactured by Thermoelectron Corp.). This blank registered an absorbance (optical density or O.D.) at 760 nm of approximately 0.005 above that of distilled water. In the assay, an O.D. 760 nm reading of 1.3-1.4 corresponded to approximately 10 μl of 1.00 mg/ml gallic acid. Also, for reference purposes, a commercial single strength Concord 100% grape juice (Welch's) was shown to have the equivalency in the F-C assay of approximately 0.25% gallic acid (0.25 GAE units per 100 g juice).

For the purposes of this invention, the term “polyphenolic antioxidants” and the measured concentrations thereof includes and encompasses any “phenolic antioxidant” that can also be present. This is practical because chemical assay of phenolic chemical groups, e.g., using the Folin-Ciocalteau (F-C) reagent assay, does not distinguish between simple phenolic derivative compounds and more complex polyphenolic structures. For the purposes herein, polyphenolic antioxidants represent all of the phenolic group molecular species (molecular structures) that remain soluble in a juice, e.g., following pressing, filtering and packaging of an anthocyanin-rich grape juice, a colorless (white) grape juice, tea, other juice, or other precursor edible product, for example. These polyphenolic antioxidants can include some molecules that have already undergone a limited amount of oxidation and/or polymerization due to exposure to air, light.

Polyphenolic compounds protect plants from pathogens, serve as UV sunscreens, and can repel hungry animals. As antioxidants, the phenolics can scavenge unpaired electrons (free radicals), inactivate reactive oxygen species, and chelate metal ions that catalyze oxidation. A partial list of prevalent phenolic species include the simple cinnamic and benzoic acid derivatives, the stilbenes (2 phenolic rings), the 3 ring flavonoids (2 phenolic rings plus a flavone ring) that include catechins, flavanols, the anthocyanidins (not glycosylated) and the positively charged anthocyanins of many different structures (glycosylated anthocyanidins having colors ranging from red to blue), and the four ring ellagic acid species and its derivatives as well as a variety of tannins, to name a few.

The term “shelf life” or “shelf-stable” in the context of grape seeds and polyphenolic antioxidant extracts refers to a loss of less than 25% per year in the polyphenolic antioxidant content of the material when stored at 20° C.

A non-exclusive list of grape species that can used as a source of grape seeds as well as antioxidant extracts from skins, seeds and/or pulp includes Vitis labrusca (Concord), Vitis rotundifolia (Muscadine), Vitis vinifera (European wine grape) and combinations of these.

A “beverage” is defined as any one of various compositions that are pourable liquids for drinking either hot, at room temperature or refrigerated. Illustrative beverages include fruit juice, vegetable juice, tea, coffee, and the like.

Teas and Coffees. Regarding teas, although there are many differing traditions, arts and methods relating to steeping of teas and making tea infusions (where the amount of loose tea leaves per serving, the water temperature, and the steeping time can differ for different tea varieties, including white, green, oolong, black, pu-erh, flavored and blended teas), for the purposes of this invention the reference concentration of antioxidants for any single strength tea (e.g., for green tea, black tea and others) can be measured after the steeping of between 2.0 and 2.2 grams of any variety of dried Camellia sinensis leaves that have been equilibrated in 8 fluid ounces of hot water (water initially at 85° to about 100° C. at one atmosphere) for a period of time sufficient to remove most (75% or more) of the antioxidants from the leaves that are extractable into hot water.

Regarding coffee, for the purposes of the present invention, a reference single strength coffee beverage is prepared using two level tablespoons of ground roasted coffee beans (one standard coffee scoop) for each six ounces of brew water. The brew water is preferably heated to a temperature of about 90° C. to about 95° C. for extracting the coffee flavors and antioxidants.

### Health Benefits.

The general population benefits from regularly consuming more fruit and vegetables rich in polyphenolic antioxidants. It is clear that polyphenolic antioxidants are part of a healthy diet. This invention provides beverages that are fortified with polyphenolic antioxidants.

Polyphenolic bio-functional and molecular diversity can be provided by using a variety of sources of polyphenolic antioxidants. In principle, such diversity can permit a variety of health conditions to be treated with regular dietary intake of a single fortified beverage fortified using complementary fruit/vegetable materials containing multiple polyphenolic antioxidants rather than a single antioxidant chemical. That is, multiple species and classes of polyphenolic molecules from multiple fruit and/or vegetable materials and extracts can be combined within a single beverage.

An increase of 25%, 50%, and preferably 70% or even 100%; i.e., a doubling, in polyphenolic antioxidant content in a beverage can be achieved for a minimal cost as described above approximately 0.2-0.5 cents per serving.

Admixture of exogenous antioxidants increases the polyphenolic antioxidant level by at least 25%, preferably 50%, and more preferably about 60%, 70%, 80%, 90%, 100%, or even more; i.e., doubled, over the endogenous level of polyphenolic antioxidant compounds present in a precursor tea, coffee or other infusion-type beverage.

In some embodiments, between 0.5 g and 1.0 g of broken or comminuted grape seeds, or alternatively between 50 mg and 100 mg of concentrated polyphenolic extract (e.g., containing 75% or more by weight phenolics) contribute (in gallic acid equivalent grams) between about 25 mg to about 50 mg phenolics, or contribute between about 50 mg to about 100 mg phenolics.

Polyphenol-rich extracts have been prepared from grape seeds alone. Without the presence of grape skins, a substantially anthocyanin-free and color-free extract is produced that can be used to fortify lightly colored, e.g., tea-colored, beverages. Polyphenolic extracts are also obtained from other fruit and vegetable materials such as pomegranates, green coffee beans, tea leaves, raspberry fruit and leaves, strawberries, blueberries, and many other fruits and vegetable sources.

One common measurement (and alternative to the GAE measurement) for the amount of antioxidants present in a beverage is the “Oxygen Radical Absorbance Capacity” or ORAC value. It is measured in units of micromoles Trolox® [6-hydroxy-2,5,7,8-tetramethylchroman-2-carboxylic acid] per gram of beverage being assayed, where one ORAC unit corresponds to one micromole of Trolox®, a water-soluble analog of vitamin E.

In recent years, the scientific literature has suggested that different species of polyphenolic molecules can exhibit different biochemical properties and provide different health benefits when consumed regularly in the human diet. It has also been appreciated that a great diversity exists among polyphenolic molecular species synthesized in different varieties of grapes, and even within the same grape variety harvested at different times of the season (and presumably within their seeds).

It is believed that by combining the great variety of polyphenolic antioxidants from grape seeds and teas, for example, the health benefit obtained from the combination is greater than that of either separately. It is contemplated that in some instances, the antioxidants from tea and grape seed be combined in approximately equal proportions based upon their polyphenolic antioxidant activities as measured in ORAC or GAE units.

The concept that a diversity and balance between the glycosylated and aglycone polyphenols is also desirable. For example, with acai berries, Del Pozo-Insfran et al., J. Agric. Chem. (2006) 54(4):1222-1229 demonstrated that the glycosylated forms of polyphenolic acids and flavanols were more potent in affecting leukemia cell proliferation and cell death in culture than aglycone forms.

### Composition of Exemplary Tea Beverages.

For traditional teas, i.e., Camellia sinensis-based teas, the reference concentration of antioxidants, e.g., total phenolics, present in a single strength tea can be measured following the brewing of approximately 2.0 grams of Camellia sinensis leaves dried and equilibrated at room temperature and humidity in 8 fluid ounces of water. A survey of a variety of single-use tea bags produced by companies including Lipton, Twinings and Celestial Seasonings shows that these bags contain between 2.0 and 2.3 g dried Camellia sinensis leaves. Sufficient brewing time is allowed to extract most (e.g., 80% or more) of the water-soluble antioxidants from both tea leaves and added sources of phenolic antioxidants such as grape seed flours and grape seed extracts. Between three and seven minutes, typically 4-5 minutes of brew time in 80-90° C. water has been found sufficient to extract more than 80% of the water-soluble antioxidants from the above vegetable materials.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. Thus, such additional embodiments are within the scope of the present invention and the following claims.

Unless otherwise defined herein, all terms have their ordinary meanings as understood by one of ordinary skill in the field to which the invention pertains. The use of the article “a” or “an” is intended to include one or more.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A dry composition that is brewed with water to produce an infusion beverage, comprising
fruit-derived or vegetable-derived particulate solids or both that provide flavor in said infusion beverage; and
a separate artificially produced particulate material comprising at least one bioactive component that is released into said fusion beverage, wherein said particulate material is configured to remain substantially distributed throughout said dry composition.

2. The composition of claim 1, wherein said particulate material contains a plurality of bioactive components.

3. The composition of claim 1, wherein said at least one bioactive component comprises a water-dispersible phenolic antioxidant.

4. The composition of claim 1, wherein said at least one bioactive component includes at least one water-dispersible vitamin.

5-7. (canceled)

8. The composition of claim 1, wherein said particulate material comprising at least one bioactive component is a plant derived particulate carrier material carrying said at least one bioactive component.

9. The composition of claim 8, wherein said carrier material is selected from the group consisting of corncob particles, rice hull particles, nut shell particles, fruit seed particles, vegetable seed particles, and combinations thereof

10-11. (canceled)

12. A dry composition that is brewed with hot water to produce an infusion beverage, wherein said composition comprises
a first pre-measured amount of fruit-derived or vegetable-derived dry particulate solids or both that provide flavor, combined with
a second pre-measured amount of antioxidant-containing material sufficient to release during brewing at least 25 mg of water-dispersible phenolic antioxidants (measured as gallic acid equivalents) per serving of said beverage, wherein said antioxidant-containing material is configured and arranged to remain distributed throughout or around said dry composition.

13. The composition of claim 12, wherein said phenolic antioxidants are derived from the seeds of non-fermented grapes.

14-15. (canceled)

16. The composition of claim 12, wherein said fruit and/or vegetable-derived particulate solids are selected from the group consisting of teas, coffees and cocoa-containing particulate solids.

17-24. (canceled)

25. The composition of claim 12, wherein said antioxidant-containing material comprises comminuted grape seeds or grape seed extract or both.

26. The composition of claim 25, wherein between 0.25 g and 3.0 g of said comminuted grape seeds are provided per serving of said beverage.

27. The composition of claim 25, wherein at least 80% by weight of the water-dispersible phenolic antioxidants contained in said comminuted grape seeds is released during brewing within 5 minutes after adding at least 4 ounces of hot water at a temperature of between 70 and 100° C.

28. The composition of claim 25, wherein said comminuted grape seeds are provided in a physical form selected from the group consisting of broken grape seeds, grape seed flour, granulated grape seed flour and combinations thereof that allows rapid release of said phenolic antioxidants into said infusion beverage.

29. The composition of claim 25, wherein said comminuted grape seeds are prepared from grape seeds that have been pressed to remove endogenous grape seed oil.

30. The composition of claim 25, wherein said grape seed extract contains at least 90% y weight phenolic antioxidants measured as gallic acid equivalents.

31. The composition of claim 25, wherein said grape seed extract is prepared without the use of any synthetic chemical solvent.

32. A beverage prepared using a composition of claim 1.

33. (canceled)

34. A method of producing an infusion beverage, comprising
combining a quantity of the composition of claim 1 with at least 4 fluid ounces of hot water at a temperature of between 10 and 100° C., wherein the relative quantities of said composition and said water are suitable for forming said infusion beverage, and
brewing the combination of said composition and said water for a time interval sufficient to release at least 25 mg of said phenolic antioxidants into said beverage, thereby forming a phenolic antioxidant-supplemented infusion beverage.

35. (canceled)
